(19) United States
(12) Patent Application Publication
(10) Pub. No.: US 2026/0094980 A1
(43) Pub. Date: Apr. 2, 2026

(54) TERMINAL CONNECTION STRUCTURE

(71) Applicant: JAPAN AVIATION ELECTRONICS INDUSTRY, LIMITED, Tokyo (JP)

(72) Inventor: Osamu HASHIGUCHI, Tokyo (JP)

(73) Assignee: JAPAN AVIATION ELECTRONICS INDUSTRY, LIMITED, Tokyo (JP)

(21) Appl. No.: 19/309,859

(22) Filed: Aug. 26, 2025

(30) Foreign Application Priority Data
Sep. 30, 2024 (JP) 2024-170952

(51) Int. Cl. H01R 4/48

(52) U.S. Cl. CPC H01R 4/48

(57) ABSTRACT

A terminal connection structure includes: a first terminal and a second terminal which overlap with each other and whose relative parallel movement in a plane is restrained; and a clamp which presses the first terminal and the second terminal against each other in a normal direction of the plane so as to restrain relative movement of the first terminal and the second terminal in the normal direction. The first terminal and the second terminal are in three-point contact with each other, and a tangent plane at each of three contact points in the three-point contact is inclined with respect to the plane.

### TECHNICAL FIELD

The present disclosure relates to a terminal connection structure of a first terminal and a second terminal which overlap with each other and whose relative parallel movement in a plane is restrained and in more detail, relates to a terminal connection structure in which a first terminal and a second terminal are in a three-point contact with each other without requiring high machining accuracy.

### BACKGROUND ART

Japanese Patent Application Laid Open No. 2024-037491 (hereinafter, referred to as Patent Literature 1) is known as the terminal connection structure of a first terminal and a second terminal which overlap with each other and whose relative parallel movement in a plane is prevented. In Patent Literature 1, the first terminal and the second terminal are called a first bus bar and a second bus bar respectively. FIG. 1(a) is a copy of FIG. 2 of Patent Literature 1, FIG. 1(b) is a copy of FIG. 3 of Patent Literature 1, and FIG. 1(c) is a copy of FIG. 6 of Patent Literature 1.

Patent Literature 1 discloses the following technical matters.

1. “The first bus bar 11 and the second bus bar 12 are arranged on top of each other, with two or more concave portions 111 and two or more convex portions 121 fitted to each other. That is, the first bus bar 11 and the second bus bar 12 are simply connected. Accordingly, the first bus bar 11 and the second bus bar 12 are prevented from being displaced in the front-back direction and the left-right direction.” (Paragraph 0021 in Patent Literature 1)
2. “The first bus bar 11 and the second bus bar 12 which are arranged on top of each other are pressed and fixed by a clip 13 in the up-down direction.” (Paragraph 0021 in Patent Literature 1)
3. “The convex portion 121 and the concave portion 111 have a rectangular parallelepiped shape corresponding to the convex portion 121, but the convex portion and the concave portion can be of any shape as long as the convex portion and the concave portion can be fitted to each other.” (Paragraph 0019 in Patent Literature 1)
4. “The material, shape, dimension, value, form, number, location, and the like of each component in the embodiment are arbitrary and not limited as long as the present invention can be achieved.” (Paragraph 0025 in Patent Literature 1)

According to Patent Literature 1, the size of a gap between two objects which are fitted to each other (these are the convex portion 121 and the concave portion 111 in Patent Literature 1) is a matter of design. Therefore, according to Patent Literature 1, by designing the gap between the convex portion 121 and the concave portion 111, which are fitted to each other, to be sufficiently small, parallel movement of the second bus bar 12 with respect to the first bus bar 11 in the front-back direction and the left-right direction can be prevented.

Thus, Patent Literature 1 discloses “a terminal connection structure including: a first terminal and a second terminal which overlap with each other and whose relative parallel movement in a plane is prevented; and a clamp which presses the first terminal and the second terminal on each other in a normal direction of the plane so as to prevent relative movement of the first terminal and the second terminal in the normal direction.”

According to Patent Literature 1, in order to prevent relative parallel movement in a plane, it is necessary to fit the convex portion 121 and the concave portion 111 to each other in a direction parallel to a plane including the front-back direction and the left-right direction. This requires precision metal machining.

### BRIEF STATEMENT OF INVENTION

In the light of such prior arts, a terminal connection structure of a first terminal and a second terminal which overlap with each other and whose relative parallel movement in a plane is restrained is disclosed, in which the first terminal and the second terminal are in a three-point contact with each other without requiring high machining accuracy.

Technical matters described herein are neither intended to explicitly or implicitly limit inventions recited in the claims nor intended to allow any person other than those benefiting from the present invention (for example, the applicant and proprietors) to limit the inventions recited in the claims, and are merely provided to facilitate understanding of the gist of the present invention. The outline of the present invention from another viewpoint can be appreciated, for example, from the claims at the time of filing of this patent application.

A terminal connection structure according to the present disclosure includes: a first terminal and a second terminal which overlap with each other and whose relative parallel movement in a plane is restrained; and a clamp which presses the first terminal and the second terminal on each other in a normal direction of the plane so as to restrain relative movement of the first terminal and the second terminal in the normal direction. The first terminal and the second terminal are in three-point contact with each other, and a tangent plane at each of three contact points in the three-point contact is inclined with respect to the plane.

According to the terminal connection structure disclosed in the present specification, the first terminal and the second terminal are in three-point contact with each other and a tangent plane at each of three contact points in the three-point contact is inclined with respect to a plane. Accordingly, the terminal connection structure of the first terminal and the second terminal which overlap with each other and whose relative parallel movement in the plane is restrained is realized without requiring high machining accuracy.

### BRIEF DESCRIPTION OF THE DRAWINGS

FIGS. 1A-1C are drawings illustrating a terminal connection structure of prior art. FIG. 1A is a perspective view of the terminal connection structure of prior art, FIG. 1B is a perspective view of the terminal connection structure of prior art, in which two bus bars are not fitted together, and FIG. 1C is a cross-sectional view of the terminal connection structure of prior art, illustrating a partial structure for the two bus bars fitting together.

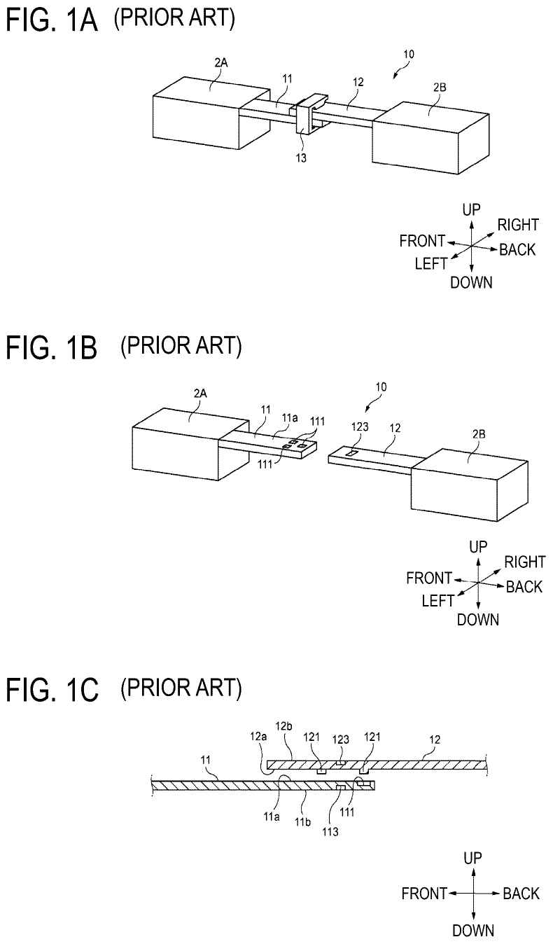

FIG. 2 is a plan view of a terminal connection structure according to an embodiment.

FIGS. 3A-3C are drawings illustrating a terminal connection structure of a first example. FIG. 3A is an exploded perspective view, FIG. 3B is an exploded perspective view, and FIG. 3C is a partial cross-sectional view at a convex portion.

FIGS. 4A-4C are drawings illustrating a terminal connection structure of a second example. FIG. 4A is an exploded perspective view, FIG. 4B is an exploded perspective view, and FIG. 4C is a partial cross-sectional view at a convex portion.

FIGS. 5A-5C are drawings illustrating a terminal connection structure of a third example. FIG. 5A is an exploded perspective view, FIG. 5B is an exploded perspective view, and FIG. 5C is a partial cross-sectional view at a convex portion.

FIGS. 6A-6C are drawings illustrating a terminal connection structure of a fourth example. FIG. 6A is an exploded perspective view, FIG. 6B is an exploded perspective view, and FIG. 6C is a partial cross-sectional view at a convex portion.

FIGS. 7A-7C are drawings illustrating a terminal connection structure of a fifth example. FIG. 7A is an exploded perspective view, FIG. 7B is an exploded perspective view, and FIG. 7C is a partial cross-sectional view at a convex portion.

FIGS. 8A-8C are drawings illustrating a terminal connection structure of a sixth example. FIG. 8A is an exploded perspective view, FIG. 8B is an exploded perspective view, and FIG. 8C is a partial cross-sectional view at a convex portion.

FIGS. 9A-9C are drawings illustrating a terminal connection structure of a seventh example. FIG. 9A is an exploded perspective view, FIG. 9B is an exploded perspective view, and FIG. 9C is a partial cross-sectional view at a convex portion.

FIGS. 10A-10C are drawings illustrating a terminal connection structure of an eighth example. FIG. 10A is an exploded perspective view, FIG. 10B is an exploded perspective view, and FIG. 10C is a partial cross-sectional view at a convex portion.

FIG. 11 is a partial cross-sectional view of a terminal connection structure at one of three contact points in the three-point contact of a first terminal and a second terminal.

### LIST OF REFERENCE NUMERALS

1: terminal connection structure
10: first terminal
12: concave portion
12a: surface
20: second terminal
22: convex portion
22a: surface
30: clamp
40: plane
50: tangent plane

### DETAILED DESCRIPTION

A terminal connection structure disclosed will be described with reference to the accompanying drawings. The drawings are provided to facilitate understanding of embodiments and the dimensions of each component illustrated in the drawings are not necessarily the same as the actual dimensions. In each drawing, only some of components of two or more identical components are provided with reference numerals for ease of viewing.

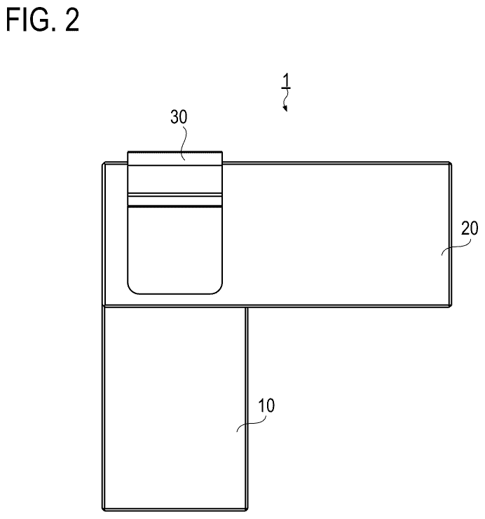

As illustrated in FIG. 2, a terminal connection structure 1 of an embodiment includes a first terminal 10, a second terminal 20, and a clamp 30. Each of the first terminal 10 and the second terminal 20 is, for example, a rectangular flat-plate like metal piece. The first terminal 10 and the second terminal 20 overlap with each other in a state in which portion of one surface of the first terminal 10 and portion of one surface of the second terminal 20 face each other, and the first terminal 10 and the second terminal 20 are in three-point contact with each other (that is, the first terminal 10 and the second terminal 20 are in contact with each other at three points which are not on the same straight line). A tangent plane at each of three contact points in the three-point contact is inclined with respect to a plane defined by the three-point contact. Specifically, contacts in the three-point contact are contacts between three first portions in a surface 12a or three first surfaces 12a on the first terminal 10 and respective three second portions on a surface 22a or three second surfaces 22a on the second terminal 20. What is well known about a three-point contact is that directions of components, in a plane defined by the three-point contact, of normal forces at the three points are different from each other and the components are balanced in the plane. Therefore, relative parallel movement of the first terminal 10 and the second terminal 20 is restrained in the plane defined by the three-point contact.

The clamp 30 presses the first terminal 10 and the second terminal 20 against each other in a normal direction of the plane defined by the three-point contact in the state in which the first terminal 10 and the second terminal 20 are in three-point contact with each other, so as to restrain relative movement of the first terminal 10 and the second terminal 20 in the normal direction. The clamp 30 is, for example, a U-shaped clip.

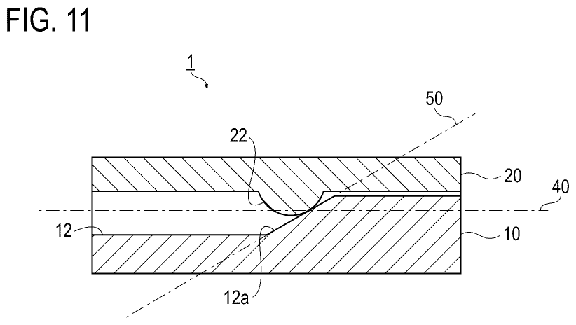

According to the terminal connection structure 1, the first terminal 10 and the second terminal 20 are in three-point contact with each other, and a tangent plane 50 at each of three contact points in the three-point contact is inclined with respect to a plane 40 defined by the three-point contact (see FIG. 11). The gradients of the tangent planes 50 absorb dimensional variations generated due to machining accuracy which is not high. Thus, a terminal connection structure of a first terminal and a second terminal which overlap with each other and whose relative parallel movement in a plane is restrained is realized without requiring high machining accuracy.

Hereinafter, specific examples of the three-point contact in the terminal connection structure 1 will be illustrated in the drawings. In each example, an angle formed by a tangent plane 50 and a plane 40 defined by a three-point contact is 30 degrees.

### First Example

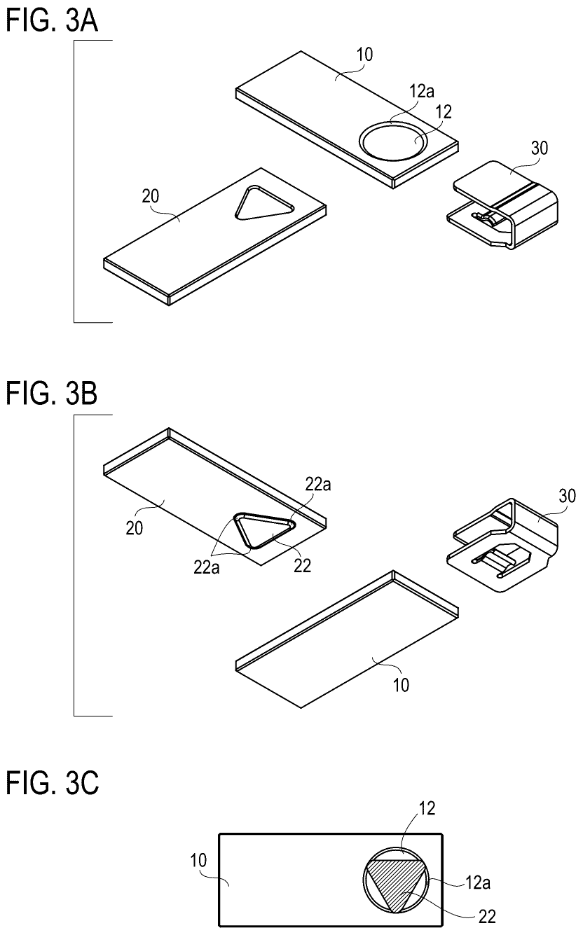

FIGS. 3A-3C illustrate a first example of the terminal connection structure 1. In the first example, the first terminal 10 has one concave portion 12 and the second terminal 20 has one convex portion 22. A peripheral wall of the concave portion 12 of the first terminal 10 has a surface 12a for a three-point contact and a surface of the convex portion 22 of the second terminal 20 has surfaces 22a for the three-point contact. In the example illustrated in FIGS. 3A-3C, the concave portion 12 of the first terminal 10 has a shape which fits a truncated cone, whereas the convex portion 22 of the second terminal 20 has a shape of a truncated triangular pyramid with three rounded ridges. The entire peripheral wall of the concave portion 12 corresponds to the surface 12a, and the convex curved surfaces obtained by rounding the ridges correspond to the three surfaces 22a.

### Second Example

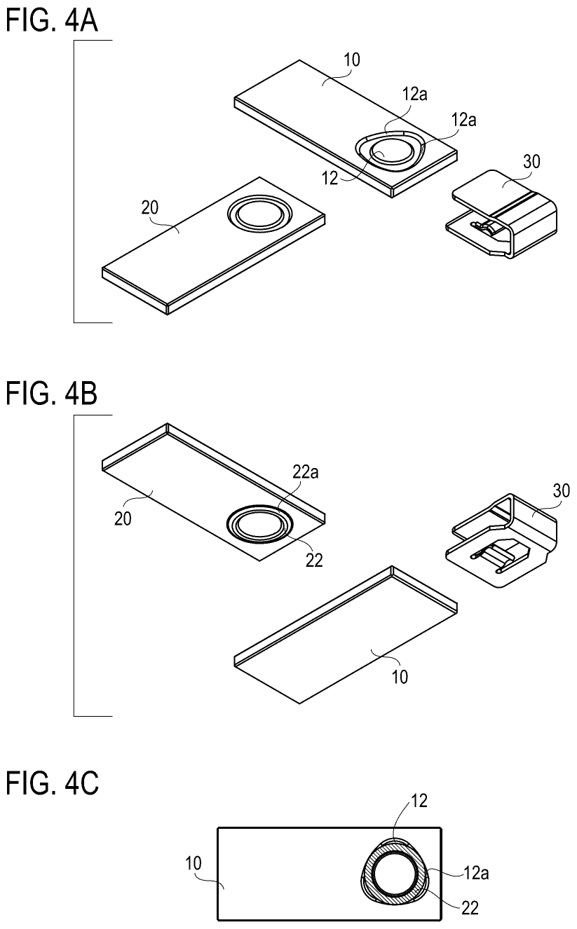

FIGS. 4A-4C illustrate a second example of the terminal connection structure 1. In the second example, the first terminal 10 has one concave portion 12 and the second terminal 20 has one convex portion 22. A peripheral wall of the concave portion 12 of the first terminal 10 has the surfaces 12a for a three-point contact and a surface of the convex portion 22 of the second terminal 20 has the surface 22a for the three-point contact. In the example illustrated in FIGS. 4A-4C, the concave portion 12 of the first terminal 10 has a shape which fits a hollow truncated cone having a Reuleaux triangle with three rounded corners at its base, whereas the convex portion 22 of the second terminal 20 has a shape of a hollow truncated cone. Portions of the peripheral wall of the concave portion 12 excluding the rounded corners correspond to the surfaces 12a, and an outer peripheral surface of the convex portion 22 corresponds to the surface 22a.

### Third Example

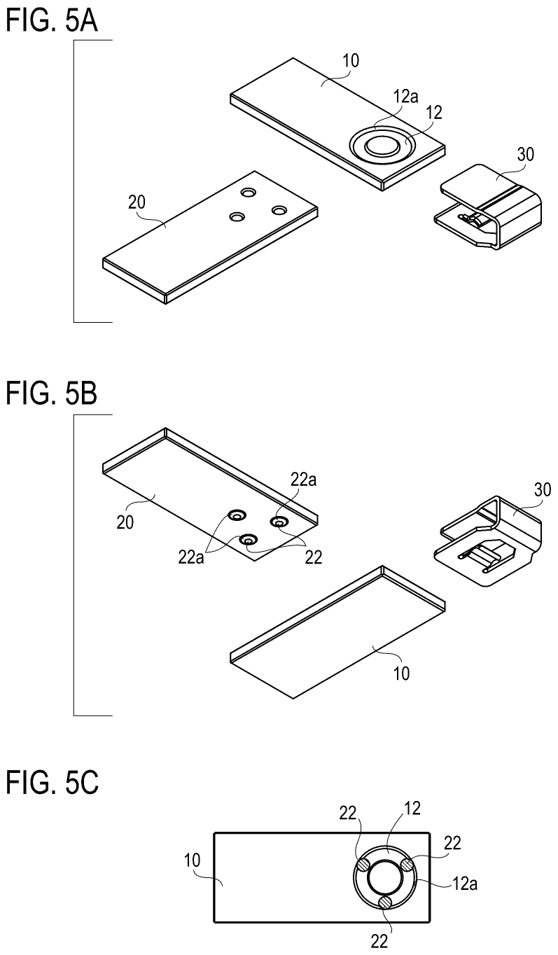

FIGS. 5A-5C illustrate a third example of the terminal connection structure 1. In the third example, the first terminal 10 has one concave portion 12 and the second terminal 20 has three convex portions 22. A peripheral wall of the concave portion 12 of the first terminal 10 has the surface 12a for a three-point contact and a surface of each of the three convex portions 22 of the second terminal 20 has the surface 22a for the three-point contact. In the example illustrated in FIGS. 5A-5C, the concave portion 12 of the first terminal 10 has a shape which fits a hollow truncated cone, whereas the convex portion 22 of the second terminal 20 has a semispherical shape. The entire peripheral wall of the concave portion 12 corresponds to the surface 12a, and the semispherical surface of the convex portion 22 corresponds to the surface 22a.

### Fourth Example

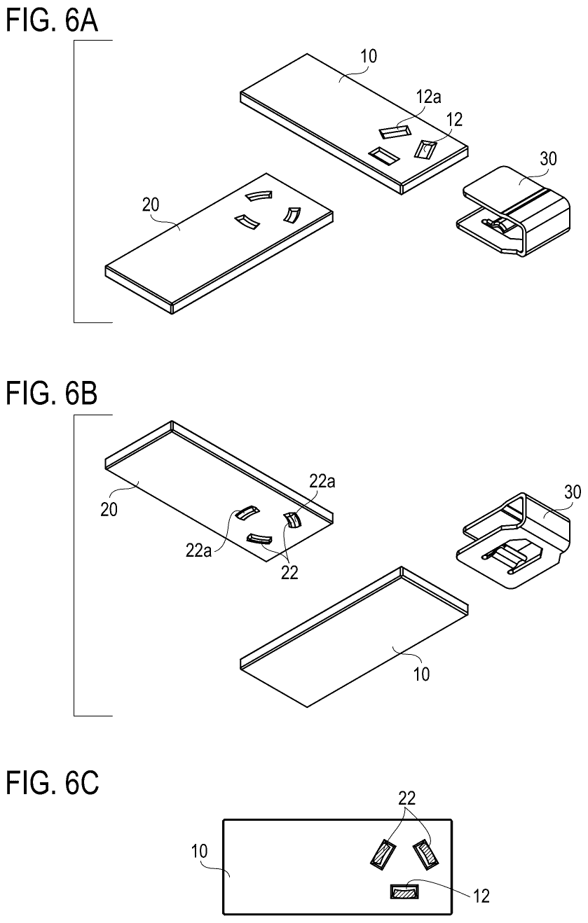

FIGS. 6A-6C illustrate a fourth example of the terminal connection structure 1. In the fourth example, the first terminal 10 has three concave portions 12 and the second terminal 20 has three convex portions 22. A peripheral wall of each of the three concave portions 12 of the first terminal 10 has the surface 12a for a three-point contact and a surface of each of the three convex portions 22 of the second terminal 20 has the surface 22a for the three-point contact. In the example illustrated in FIGS. 6A-6C, each of the three concave portions 12 of the first terminal 10 has a shape which fits a truncated quadrangular pyramid, whereas each of the three convex portions 22 of the second terminal 20 has a shape of a part cut out from a hollow truncated cone. The peripheral wall of the concave portion 12 corresponds to the surface 12a, and an outer side surface of the convex portion 22 corresponds to the surface 22a.

### Fifth Example

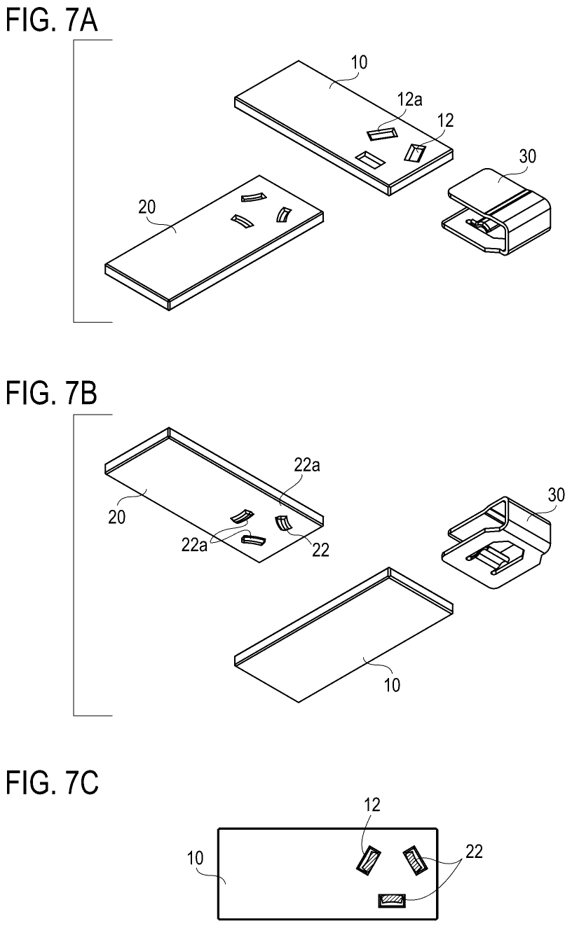

FIGS. 7A-7C illustrate a fifth example of the terminal connection structure 1. The fifth example is a modification of the fourth example. Three convex portions 22 of the second terminal 20 in the fifth embodiment are arranged point symmetrically with respect to the three convex portions 22 of the second terminal 20 in the fourth example.

### Sixth Example

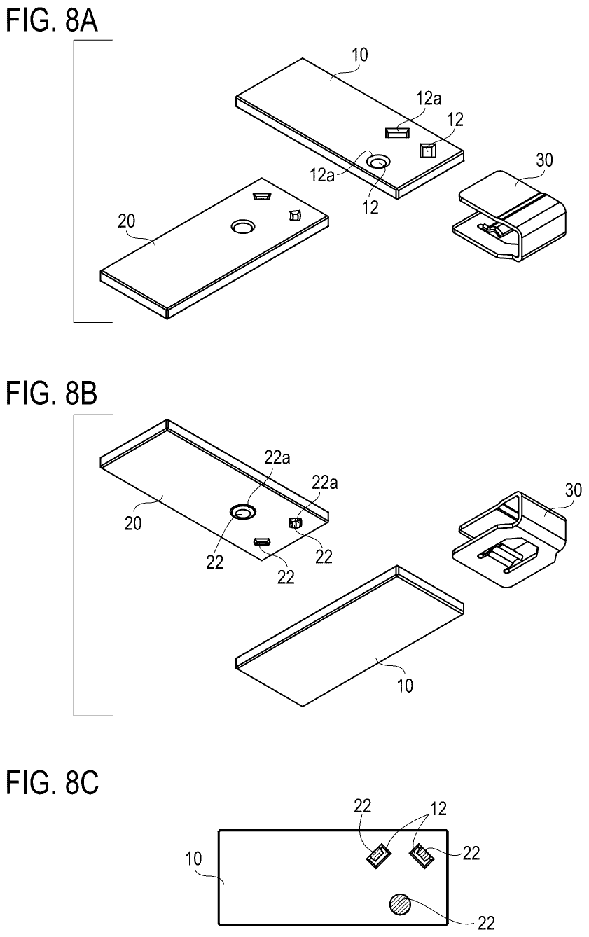

FIGS. 8A-8C illustrate a sixth example of the terminal connection structure 1. The sixth example is a modification of the fourth example. In the sixth example, the entire peripheral wall of one concave portion 12 out of the three concave portions 12 of the first terminal 10 is the surface 12a for a three-point contact having a shape following a side surface of a truncated cone, and the entire side wall of one convex portion 22 out of the three convex portions 22 of the second terminal 20 is the surface 22a for the three-point contact having a shape following the side surface of the truncated conc.

### Seventh Example

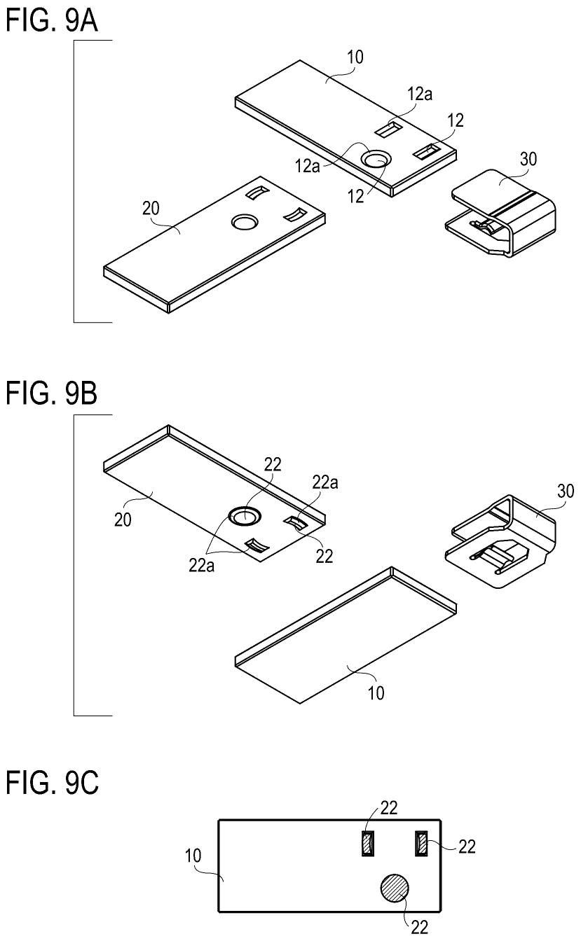

FIGS. 9A-9C illustrate a seventh example of the terminal connection structure 1. The seventh example is a modification of the sixth example. In the seventh example, each of the other two concave portions 12 out of the three concave portions 12 of the first terminal 10 is arranged so that short sides thereof are in parallel with long sides of the first terminal 10 and long sides thereof are in parallel with short sides of the first terminal 10.

### Eighth Example

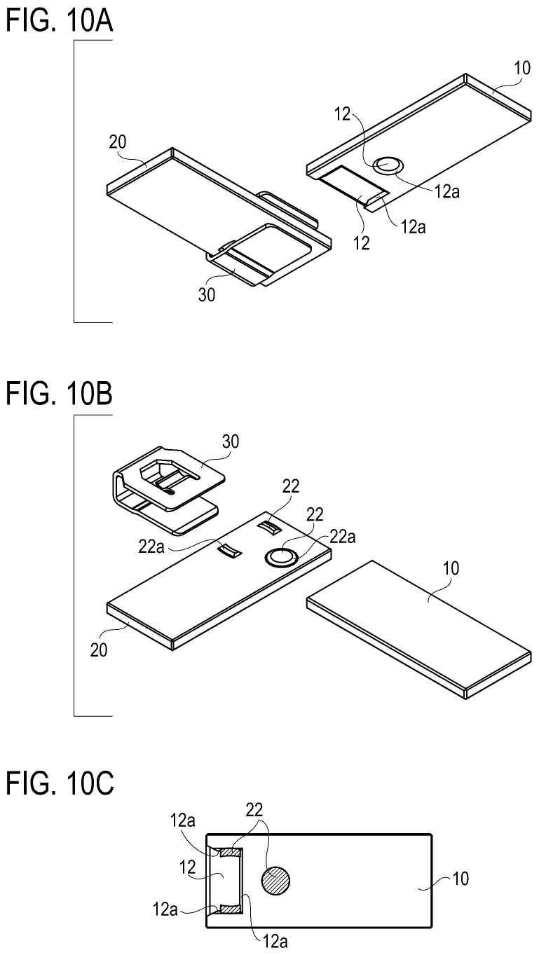

FIGS. 10A-10C illustrate an eighth example of the terminal connection structure 1. In the eighth example, the first terminal 10 has two concave portions 12 and the second terminal 20 has three convex portions 22. A peripheral wall of each of the two concave portions 12 of the first terminal 10 has the surface 12a for a three-point contact and each surface of the three convex portions 22 of the second terminal 20 has the surface 22a for the three-point contact. In the example illustrated in FIGS. 10A-10C, one concave portion 12 out of the two concave portions 12 of the first terminal 10 has a shape which fits a truncated cone, the other concave portion 12 has a shape which fits a truncated quadrangular pyramid, and the other concave portion 12 reaches an edge of the first terminal 10, whereas the three convex portions 22 of the second terminal 20 are the same as those in the seventh example. Each of peripheral walls, specifically the peripheral wall of the concave portion 12 having the shape which fits a truncated cone and the three peripheral walls of the concave portion 12 having the shape which fits a truncated quadrangular pyramid, corresponds to the surface 12a. In the terminal connection structure 1 of the eighth example, two convex portions 22 other than the convex portion 22 having a truncated cone shape are positioned in the other concave portion 12. According to the eighth example, the first terminal 10 and the second terminal 20 can be assembled together by sliding the first terminal 10 along one surface of the second terminal 20 in a state in which the clamp 30 is attached to the second terminal 20.

As to each of the examples, the surface 12a may generally be a surface having a constant gradient or a surface having a monotonically increasing gradient toward an edge of the concave portion 12. In the latter case, the surface 12a may be, for example, an off-axis ellipsoid. Alternatively, the peripheral wall of the concave portion 12 may have a shape which follows, for example, a surface bounded by a secant plane z≈0 and a secant plane z=d of an ellipsoid expressed as x²/a²+y²/b²+z²/c²=1 (a>0, b>0, c>0, −c≤d<0) (the ellipsoid includes a spherical surface as a special case thereof), or the surface 12a may be part of this peripheral wall.

### <Addendum>

Technical features disclosed in the above-described various types of embodiments and the modifications thereof are not always mutually exclusive. A technical feature of a given embodiment or a modification thereof may be applied to a technical feature of another embodiment or a modification thereof as far as there is no contradiction from a technical viewpoint.

The claims at the time of filing of the present application do not always exhaustively claim all the inventions disclosed in this specification. In this respect, the applicant of the present application should not be understood or interpreted as waiving, before the filing, the right to obtain a patent for an invention not claimed at the time of the filing of the present application. The applicant of the present application retains the right to obtain a patent for an invention not claimed in the present application, the right to file a divisional application for the invention, the right to claim the invention by amendment, and all other rights as far as the law or the treaty of a country or a region which has accepted the filing of the present application allows. However, this shall not apply if the applicant of the present application explicitly and determinately declares a contrary intention.

While the present invention has been described with reference to the exemplary embodiments, it will be understood by those skilled in the art that various changes may be made and equivalents may be substituted for elements thereof without departing from the scope of the present invention. In addition, many modifications may be made to adapt a particular system, device, or component thereof to the teachings of the present invention without departing from the essential scope thereof. Therefore, it is intended that the present invention is not limited to the particular embodiment disclosed for carrying out this invention, but that the present invention will include all embodiments falling within the scope of the appended claims.

Moreover, the use of the terms “first”, “second”, and the like, when used in the present specification and/or the appended claims, do not denote any order or importance, but rather the terms “first”, “second”, and the like are used to distinguish one element from another. The terminology used in the present specification is for the purpose of describing the embodiments and is not intended to limit the present invention. It will be further understood that the terms “comprise” and “include” and inflected forms thereof, when used in the present specification and/or the appended claims, specify the presence of stated features, steps, operations, elements, and/or components, but do not preclude the presence or addition of one or more other features, steps, operations, elements, components, and/or groups thereof. The term “and/or”, if any, includes any and all combinations of one or more of the associated listed items. In the claims and the specification, unless otherwise specified, “connect”, “join”, “couple”, “interlock”, or synonyms therefor and all the word forms thereof do not necessarily deny the presence of one or more intermediate elements between, for example, two elements “connected” or “joined” to each other or “interlocked” with each other. In the claims and the specification, the term “any”, if any, is to be understood as a term synonymous with a universal quantifier ∀ unless otherwise specified. For example, the expression “for any X” has the same meaning as “for all X” or “for each X”. Expressions like “at least one of A, B and C”, “at least one of A, B or C”, and “at least one of A, B and/or C”, if any, mean arbitrarily choosing one member from a set P obtained by removing an empty set φ from a power set 2^{S} of a set S including all listed elements as members, unless otherwise defined. In this example, S={A, B, C}, 2^{S}={φ, {A}, {B}, {C}, {A, B}, {A, C}, {B, C}, {A, B, C}}, and P={{A}, {B}, {C}, {A, B}, {A, C}, {B, C}, {A, B, C}}. The example means that one member (for example, {A, C}) is arbitrarily chosen from the set P.

Unless otherwise defined, all terms (including technical and scientific terms) used in the present specification have the same meanings as commonly understood by those skilled in the art to which the present invention belongs. It will be further understood that terms, such as those defined in commonly used dictionaries, should be interpreted as having meanings that are consistent with their meanings in the context of the relevant art and the present disclosure and should not be interpreted in an idealized or overly formal sense unless expressly so defined herein.

In describing the present invention, it will be understood that a number of techniques and steps are disclosed. Each of these has individual benefit and each can also be used in combination with one or more, or in some cases all, of the other disclosed techniques. Accordingly, for the sake of clarity, the present specification will refrain from explaining every possible combination of the individual techniques or steps. Nevertheless, the specification and claims should be read with the understanding that such combinations are entirely within the scope of the present invention and the claims.

The corresponding structures, materials, acts, and equivalents of all means or steps plus function elements in the claims below, if any, are intended to include any structure, material, or act for performing the function in combination with other elements.

Although the embodiments of the present invention have been described above, the present invention is not limited to the embodiments. Various modifications and variations may be made without departing from the gist of the present invention. The chosen and described embodiments are for illustrating the principles of the present invention and its practical application. The present invention is used in various embodiments and with various modifications or variations, and the various modifications or variations are tailored to suit an expected purpose. All such modifications and variations are intended to be included in the scope of the present invention as determined by the appended claims and are intended to be provided with comparable protection when interpreted in accordance with the breadth to which they are fairly, legally, and equitably entitled.

1. A terminal connection structure comprising:
a first terminal and a second terminal overlapping with each other, and being fitted together to be in three-point contact with each other, the three-point contact consisting of three contact points between the first terminal and the second terminal, the three contact points each determining a tangent plane being inclined with respect to a plane, in the plane the three-point contact restraining the first terminal and the second terminal from parallel and relatively moving along each other; and
a clamp pressing the first terminal and the second terminal against each other in a normal direction of the plane so as to restrain relative movement of the first terminal and the second terminal in the normal direction.

2. The terminal connection structure according to claim 1, wherein
the first terminal includes one concave portion having a peripheral wall,
the second terminal includes one convex portion, and
the three-point contact is a three-point contact of the peripheral wall of the one concave portion and the one convex portion.

3. The terminal connection structure according to claim 1, wherein
the first terminal includes one concave portion having a peripheral wall,
the second terminal includes three convex portions, and
the three-point contact is a three-point contact of the peripheral wall of the one concave portion and the three convex portions.

4. The terminal connection structure according to claim 1, wherein
the first terminal includes three concave portions each having a peripheral wall,
the second terminal includes three convex portions, and
the three-point contact is a three-point contact of the three concave portions and the three convex portions, the peripheral wall of each of the three concave portions being in contact with a corresponding one of the three convex portions.

5. The terminal connection structure according to claim 4, wherein
the peripheral wall of one out of the three concave portions has a shape following a side surface of a truncated cone, and
one out of the three convex portions has a side wall having a shape following the side surface of the truncated cone.

6. The terminal connection structure according to claim 1, wherein
the first terminal includes two concave portions each having a peripheral wall,
the second terminal includes three convex portions,
the three-point contact is a three-point contact of the two concave portions and the three convex portions, one of the three convex portions being in contact with the peripheral wall of one of the two concave portions, and the remaining two of the three convex portions being in contact with the peripheral wall of the remaining one of the two concave portions, and the remaining one of the two concave portions reaching an edge of the first terminal.
